(19) United States
(12) Patent Application Publication
(10) Pub. No.: US 2025/0056340 A1
(43) Pub. Date: Feb. 13, 2025

(54) HANDOVER

(71) Applicant: Nokia Technologies Oy, Espoo (FI)

(72) Inventors: Shehzad Ali ASHRAF, Munich (DE); Panagiotis SPAPIS, Munich (DE); Umur KARABULUT, Munich (DE); Srinivasan SELVAGANAPATHY, Bangalore (IN)

(21) Appl. No.: 18/799,324

(22) Filed: Aug. 9, 2024

(30) Foreign Application Priority Data
Aug. 10, 2023 (IN) 202341053790

(51) Int. Cl. H04W 36/00; H04W 36/08; H04W 36/24

(52) U.S. Cl. CPC H04W 36/0072; H04W 36/087; H04W 36/249

(57) ABSTRACT

An apparatus configurable for operation as a central unit (CU), the apparatus comprising: means for enabling lower-layer triggered mobility (LTM) random access by a user equipment (UE) to a target distributed unit (DU), for early timing advance acquisition, using a contention-free-random-access (CFRA) resource, for early timing advance acquisition by the UE, reserved for the UE against use by UEs served by different DUs. An apparatus configurable for operation as a distributed unit (DU), the apparatus comprising: means for enabling lower-layer triggered mobility (LTM) random access by a user equipment (UE) to a target distributed unit (DU), for early timing advance acquisition, using a contention-free-random-access (CFRA) resource, for early timing advance acquisition by the UE, reserved for the UE against use by UEs served by different DUs.

### TECHNOLOGICAL FIELD

Examples of the disclosure relate to contention free random access. Some relate to using contention free random access for handover between cells controlled by different distributed units.

### BACKGROUND

Handover transfers an ongoing communication session of a user equipment (UE) from one cell to another cell in connected state. Handover is used to provide continuity of service for the user, especially while the user is on the move.

Historically cell level mobility has been configured at layer-3 (e.g. radio resource control RRC). The network controls UE mobility based on UE measurement reporting. The trigger for completing handover can be the network, or with conditional handover, the user equipment. Conditional handover is executed by the user equipment only when a network configured execution condition is met. The handover decision is made on layer 3 measurements.

Dual Active Protocol Stack (DAPS) handover allows a user equipment to initiate a handover to a target cell while maintaining the connection with the source cell by activating two protocol stacks, one for the source cell and the other for the target cell.

Lower layer triggered mobility (LTM) enables handover via L1/L2 signaling, while keeping configuration of the upper layers and/or minimizing changes of configuration of the lower layers. The network triggers a LTM cell switch by sending a MAC control element (CE) to the UE.

In contention free random access (CFRA) a dedicated CFRA resource is configured per UE and this resource is unique i.e., no other UE can use this resource. This has an advantage that there is no possibility of collision when sending a preamble, based on the dedicated CFRA resource, over PRACH. The CFRA resource needs to be uniquely configured per UE (i.e., multiple UEs cannot share the resources) which may result in resource scarcity, especially in dense urban deployments.

### BRIEF SUMMARY

According to various, but not necessarily all, examples there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

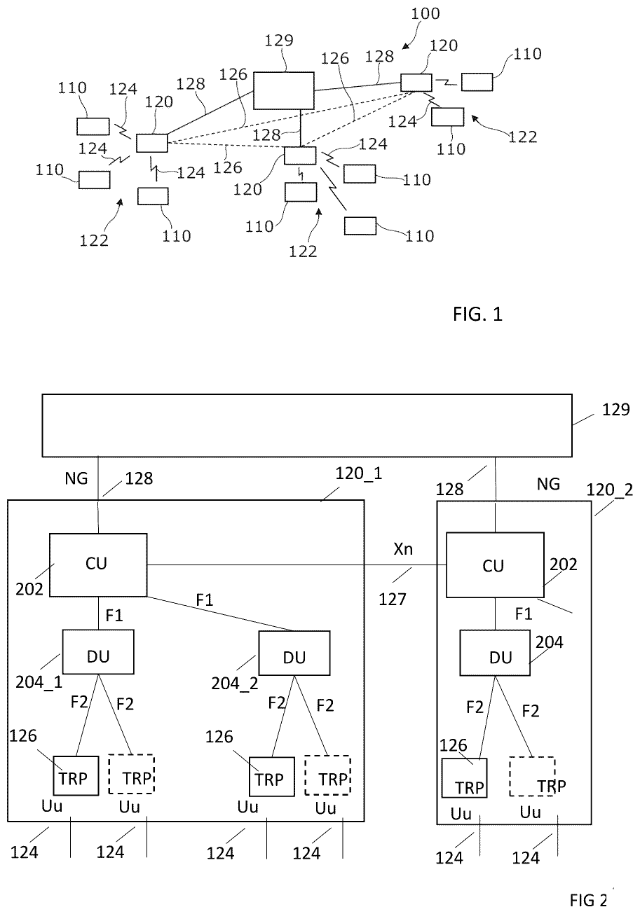

FIG. 1 to 13 show examples of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

In the following description a class (or set) can be referenced using a reference number without a subscript index (e.g. 10) and a specific instance of the class (member of the set) can be referenced using the reference number with a numerical type subscript index (e.g. 10_1) and a non-specific instance of the class (member of the set) can be referenced using the reference number with a variable type subscript index (e.g. 10_i).

### DETAILED DESCRIPTION

The description relates to apparatus 202 configured for operation as a central unit (CU), the apparatus 202 comprising:

means for enabling lower-layer triggered mobility (LTM) random access by a user equipment 110 (UE) to a target distributed unit 204_2 (tDU), for early timing advance acquisition, using a contention-free-random-access (CFRA) resource 602, for early timing advance acquisition by the UE 110, reserved for the UE 110 against use by UEs 110 served by different DUs 204.

The description relates to apparatus 204 configured for operation as a distributed unit (DU), the apparatus 204 comprising: means for enabling lower-layer triggered mobility (LTM) random access by a user equipment 110 (UE) to a target distributed unit (tDU), for early timing advance acquisition, using a contention-free-random-access (CFRA) resource 602, for early timing advance acquisition by the UE 110, reserved for the UE 110 against use by UEs 110 served by different DUs 204.

FIG. 1 illustrates an example of a network 100 comprising a plurality of network nodes including terminal nodes 110, access nodes 120 and one or more core nodes 129. The terminal nodes 110 and access nodes 120 communicate with each other. The one or more core nodes 129 communicate with the access nodes 120.

The network 100 is in this example a radio telecommunications network, in which at least some of the terminal nodes 110 and access nodes 120 communicate with each other using transmission/reception of radio waves.

The one or more core nodes 129 may, in some examples, communicate with each other. The one or more access nodes 120 may, in some examples, communicate with each other.

The network 100 may be a cellular network comprising a plurality of cells 122 each served by an access node 120. In this example, the interface between the terminal nodes 110 and an access node 120 defining a cell 122 is a wireless interface 124.

The access node 120 is a cellular radio transceiver. The terminal nodes 110 are cellular radio transceivers.

In the example illustrated the cellular network 100 is a third generation Partnership Project (3GPP) network in which the terminal nodes 110 are user equipment (UE) and the access nodes 120 are base stations.

In the example illustrated the network 100 is an Evolved Universal Terrestrial Radio Access network (E-UTRAN). The E-UTRAN consists of E-UTRAN NodeBs (eNBs) 120, providing the E-UTRA user plane and control plane (RRC) protocol terminations towards the UE 110. The eNBs 120 are interconnected with each other by means of an X2 interface 126. The eNBs are also connected by means of the S1 interface 128 to the Mobility Management Entity (MME) 129.

In other example the network 100 is a Next Generation (or New Radio, NR) Radio Access network (NG-RAN). The NG-RAN consists of gNodeBs (gNBs) 120, providing the user plane and control plane (RRC) protocol terminations towards the UE 110. The gNBs 120 are interconnected with each other by means of an X2/Xn interface 126. The gNBs are also connected by means of the N2 interface 128 to the Access and Mobility management Function (AMF).

A user equipment comprises a mobile equipment. Where reference is made to user equipment that reference includes and encompasses, wherever possible, a reference to mobile equipment.

FIG. 2 illustrates a network according to a current 3GPP specification. The network is hierarchical. It comprises a core 129 and radio access nodes 120. The core 129 connects to the radio access nodes 120 via the interface 128 (NG Interface). The radio access nodes 120 connect to user equipment via the air interface 124 (Uu). The radio access nodes 120 connect to other radio access nodes 120 via the interface 126 (Xn interface).

In this example, one or more of the radio access nodes 120 is logically split into a central unit (CU) 202 and one or more distributed units (DU) 204. A DU 204 uses one or more transmission reception points (TRP) 126.

The CU 202 controls the operation of one or more DUs 204. The CU 202 terminates the F1 interface connected with a DU 204. The CU 202 hosts higher layer protocols e.g. at least radio resource control (RRC) protocol layer and packet data convergence protocol (PDCP) protocol layer.

A DU 204 is partly controlled by a CU 202. One DU 204 supports one or multiple radio transmission points 126. One TRP 126 is supported by only one DU 204. The DU 204 terminates the F1 interface connected with the CU 202. The DU 204 hosts lower layer protocols e.g. radio link control (RLC) protocol layer, medium access control (MAC) protocol later and physical (PHY) protocol layer. The DU 204 may communicate via the dedicated interface (e.g. an F1 interface) to a RRC layer hosted by the CU 302.

The interface 127 supports the exchange of information between the CUs 202 of two different radio access nodes 120. The interface 127 enables the inter-connection of radio access nodes 120 supplied by different manufacturers. In at least some examples, data exchange over the interface 127 is between two radio access nodes 120 that belongs to the same operator or between operators with agreements.

Although preceding examples, use a split architecture using a central unit CU 202 and distributed units 204, other examples can use other architectures.

Although preceding examples, use a split architecture using a central unit CU 202 and distributed units 204 where there is no direct DU to DU communication, other examples could use other architectures where there is direct DU to DU communication. The identification of the serving DU can then be provided directly to the target DU (without going via the CU). The sub-set of CFRA resources can then be provided directly to the serving DU by the target DU (without going via the CU).

Although the following examples, use contention free random access as a part of lower layer triggered mobility (LTM) handover (HO), the CFRA resources can be used for any random-access procedure.

Lower layer triggered mobility (LTM) is a lower layer procedure i.e. below layer 3 and is performed by a DU 204.

The user equipment 110 can, for example, enable low-latency triggered mobility (LTM) that enables a serving cell change (handover) via low-latency signaling e.g. below layer three. The latency in handover once triggered can, for example, be less that 10 ms.

LTM is a procedure in which a network node (e.g. DU 202) receives measurement reports from UEs 110, and on their basis, the network node controls a change in UEs' serving cell(s) through a MAC CE. The network node prepares one or multiple candidate cells and provides the cell-change configuration for the prepared candidate cells to the UE. Then LTM cell switch is triggered, by selecting one of the cell-change configuration as target configuration for LTM. The trigger for selection can be at the network node (normal handover) or can be at the user equipment (conditional handover). The cell-change configuration can, for example, define information for use in a Random Access procedure 910 for connecting to a new cell. A cell-change configuration can be provided as a delta configuration (that is change relative to a reference configuration) or as a full explicit cell-change configuration.

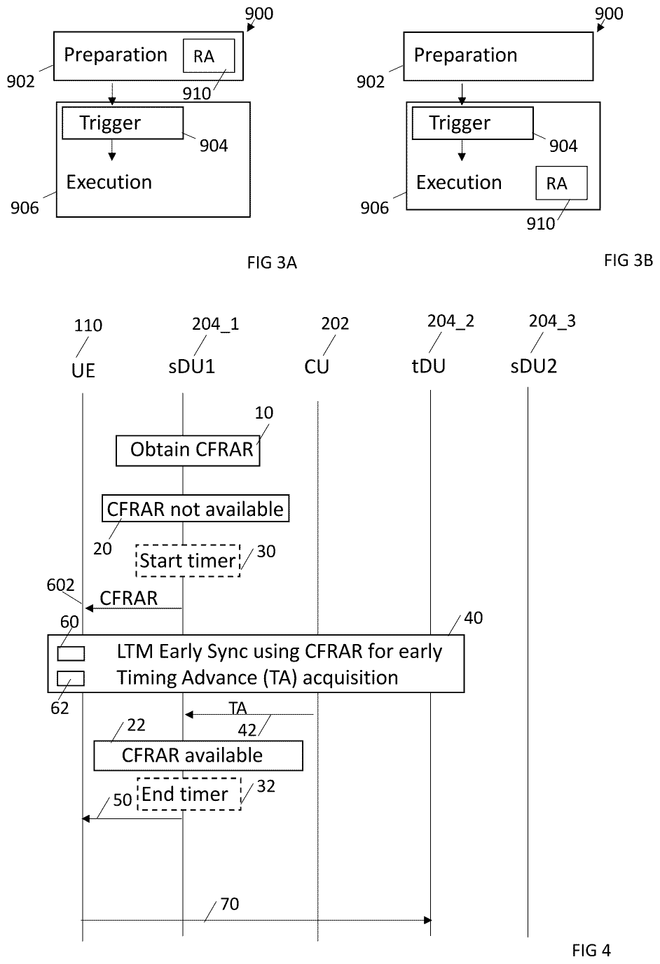

In FIG. 3A, random access 910 using the a CFRA resource 602 is before cell switch, for example during a preparation phase 902 of the LTM 900 that precedes an execution phase 304. The execution phase is triggered 904. This is early synchronization for early timing advance acquisition.

In FIG. 3B, random access 910 using the a CFRA resource 602 is after the cell switch command, during an execution phase 906 of the LTM 900 that follows a preparation phase 902 of the LTM 900. The execution phase is triggered 904

FIGS. 4, 5, 6, 7 and 8 illustrates processes that occur early, for example, before executing a cell change by a UE 110 to a cell controlled by the target distributed unit 204_2 (tDU).

A central unit 202 enables lower-layer triggered mobility (LTM) random access (RA) by a user equipment (UE) to a target distributed unit (DU), for early timing advance acquisition. The LTM RA by the UE uses a contention-free-random-access (CFRA) resource, for early timing advance acquisition by the UE, reserved for the UE against use by UEs served by different DUs.

A distributed unit 204_1 (sDU1) enables lower-layer triggered mobility (LTM) random access by a user equipment (UE) to a target distributed unit (tDU), for early timing advance acquisition, using a contention-free-random-access (CFRA) resource, for early timing advance acquisition by the UE, reserved for the UE against use by UEs served by different DUs.

The contention-free-random-access (CFRA) resource 602, for early timing advance acquisition by the UE, can be selected from a shared pool of contention-free-random-access (CFRA) resources for the target DU 204_2 (tDU). The shared pool of contention-free-random-access (CFRA) resources is for sharing by UEs served by the different DUs.

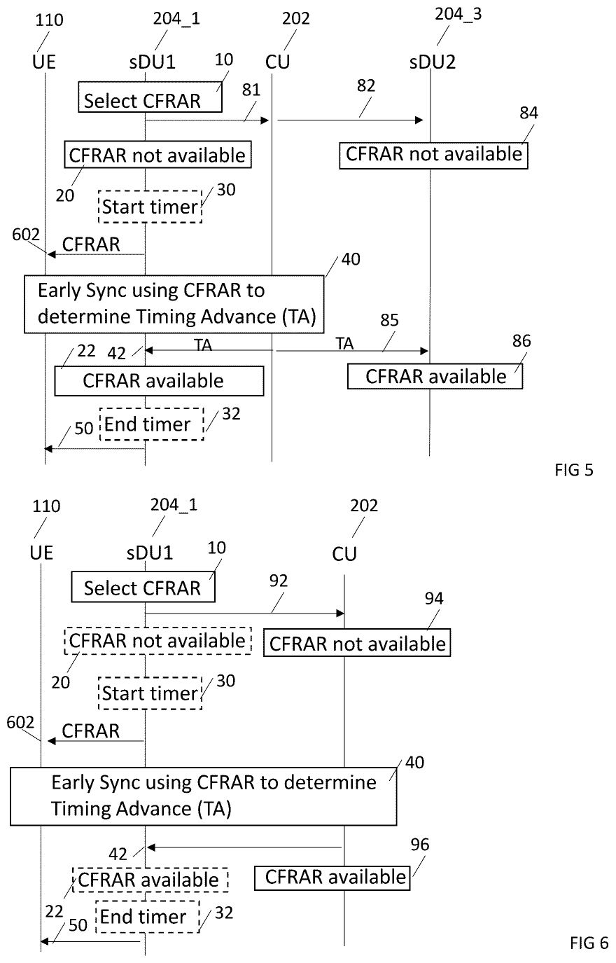

The selected contention-free-random-access (CFRA) resource 602, for early timing advance acquisition by the UE, is reserved for a UE temporarily. The reservation can be recorded centrally at a central node (FIG. 6, 7) and/or at one or more serving DUs (FIG. 4, 5, 8), for example, the serving DU 204_1 (sDU1) of the UE 110 (FIG. 4, 5) and a non-serving DU 204_3 (sDU2) of the UE (FIG. 5, 8).

In the FIGS., lower-layer triggered mobility (LTM) random access 40 by a user equipment 110 (UE) to a target distributed unit 204_2 (tDU) obtains a timing advance 42. The lower-layer triggered mobility (LTM) random access 40 uses a contention-free-random-access (CFRA) resource 602, for early timing advance acquisition by the UE 110. The contention-free-random-access (CFRA) resource 602 is reserved for the UE 110 against use by UEs 110 served by different DUs 204.

Referring to FIG. 4, in this example, the DU 204_1 (sDU1) is a serving DU and controls a cell via which the LIE 110 is connected.

The DU 204_1 (sDU1) obtains 10 a contention-free-random-access resource 602 (CFRAR), for early timing advance acquisition 40 by the UE 110.

The CFRAR is selected from a shared pool of available contention-free-random-access (CFRA) resources for the target DU 204_2 (tDU). The shared pool of contention-free-random-access (CFRA) resources is for sharing by UEs served by the different DUs.

The CFRAR, when selected, is reserved for the UE. The CFRAR is dedicated to the UE at a given point in time (i.e., during a certain time duration).

In this example, the DU 204_1 (sDU1) records 20 the CFRAR as not available. This reserves the CFRAR for the UE. The CFRAR is dedicated to the UE until the CFRAR is made available.

The DU 204_1 (sDU1) provides the obtained CFRAR 602 to the UE 110 to cause the UE 110 to perform early timing advance acquisition 40.

The UE 110 uses the CFRAR to perform early timing advance acquisition via lower-layer triggered mobility (LTM) random access by the UE to the target distributed unit (DU). The random access uses the CFRAR.

The DU 204_1 (sDU1) receives the early acquired timing advance 42 (TA) from the target DU 204_2 (tDU) via the CU 202.

The DU 204_1 (sDU1), in response to receiving the early acquired timing advance 42 (TA) from the target DU 204_2, records 22 the CFRAR as available.

The DU 204_1 (sDU1), comprises late handover decision means for commanding, in response to receiving the early acquired timing advance 42 (TA), the UE 110 to connect to the target distributed unit 204_2 (tDU) using the received early acquired timing advance 42. The cell switch command 50 sent by the DU 204_1 (sDU1) to the UE 110 can, for example, comprise the timing advance 42. The UE responds by performing access 70 using the provided timing advance.

Optionally, the DU 204_1 (sDU1), sending a cell switch command 50 is controlled by a switch timer triggered by obtaining the CFRAR. The switch timer starts 30 when the CFRAR is obtained and the cell switch command 50 is sent when the switch timer expires 32. The duration of the switch tinier count can be configured by the central unit (CU).

In some examples, a UE tinier is triggered 60 on the reception of the cell switch command 50 and the UE 110 performs random access by transmitting PRACH only when the UE timer is expired 62. The UE timer can be pre-configured or configured by CU/gNB.

FIGS. 5 & 6 illustrate examples similar to FIG. 4. In these examples, the DU 204_1 (sDU1) obtains 10 the CFRAR for early timing advance acquisition 40 by the UE 110 by selecting the CFRAR from a shared pool of available contention-free-random-access (CFRA) resources for the target DU 204_2 (tDU). The shared pool of contention-free-random-access (CFRA) resources is for sharing by UEs served by the different DUs.

Local reservation of the CFRAR at DU 204_1 (sDU1) has been previously explained with reference to FIG. 4. It reduces the pool of available CFRA resources.

FIG. 5 illustrates remote reservation of the CFRAR at DUs, for example, serving DU 204_3 (sDU2). This DU serves a different UE. FIG. 6 illustrates remote reservation of the CFRAR at the CU 202.

FIG. 5 illustrates a DU 204_1 (sDU1) serving a UE that is configured to select the CFRAR, for early timing advance acquisition by the UE, from a set of available contention-free-random-access (CFRA) resources, for early timing advance acquisition by the UE. The DU 204_1 (sDU1) provides 81, 82 the selected CFRAR to the DU 204_3 (sDU2) via the CU 202. The DU 204_3 is not serving the UE 100 but is serving a different UE (not illustrated).

The DU 204_3 (sDU2) is configured to record 84 the CFRAR as not available to UEs after obtaining the CFRAR.

The DU 204_3 (sDU2) is configured to record 86 the CFRAR as available after receiving, from the CU 202, an indication 85 that an early acquired timing advance 42 associated with the CFRAR has been received at the CU 202.

The CU 202 is configured to receive 81 the CFRAR resource from the sDU1 204_1 and to indicate 84 the received CFRAR to the different DUs.

The CFRAR, for early timing advance acquisition by the UE, is selected from a shared pool of available contention-free-random-access (CFRA) resources for the target distributed unit. The shared pool of contention-free-random-access (CFRA) resources is for sharing by UEs served by a first set of different DUs and the sDU1 204_1 serving the UE 110. The CU 202 can indicate 82 the received CFRAR resource to all the DUs of the first set or to a sub-set of the DUs of the first set.

FIG. 6 illustrates a DU 204_1 (sDU1) that is configured to select the CFRAR, for early timing advance acquisition by the UE, from a set of available contention-free-random-access (CFRA) resources, for early timing advance acquisition by the UE. The DU 204_1 (sDU1) provides the selected CFRAR to the central unit 202.

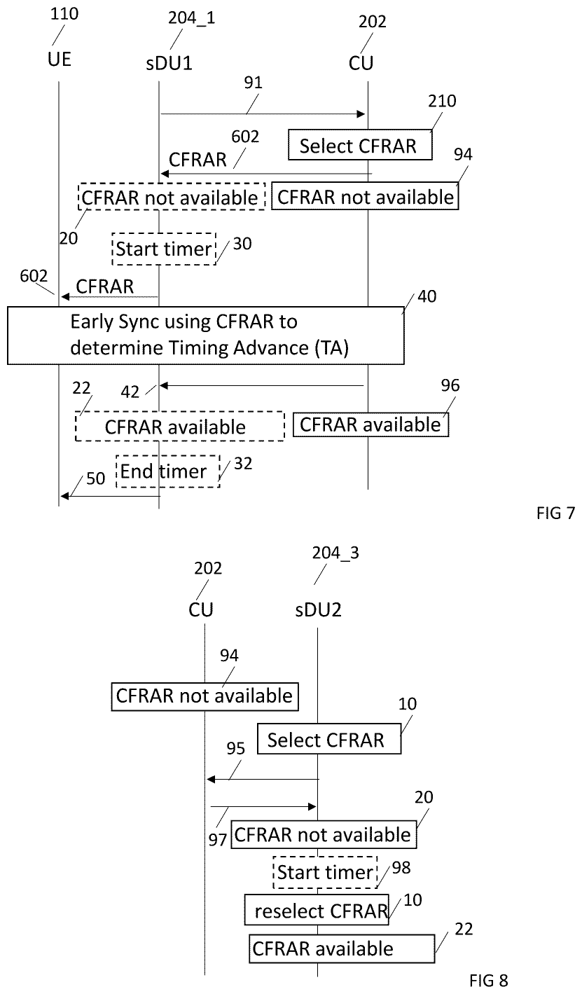

In FIGS. 6 and 7 the CU 202 is configured to reserve the CFRAR, for early timing advance acquisition by the UE, against use by UEs served by different DUs. The reservation of the CFRAR, for early timing advance acquisition by the UE 110, against use by the UEs served by the different DUs, prevents use of the CFRAR for random access by a user equipment (UE), other than the user equipment, to the target distributed unit (DU).

The CU 202 is configured to record 94 the CFRAR as not available to other UEs after obtaining the CFRAR.

The CU 202 is configured to record 66 the CFRAR as available to other UEs after receiving the early acquired timing advance 42 associated with the CFRAR. This confirms random access completion to the target DU by the UE, and enables release of the CFRAR for use by other UEs served by the different DUs.

FIG. 7 illustrates a CU 202 that is configured to select the CFRAR, for early timing advance acquisition by the UE, from a set of available contention-free-random-access (CFRA) resources, for early timing advance acquisition by the UE. The CU 202 provides the selected CFRAR to the sDU1 204_1 serving the UE 110.

In this example, the sDU1 204_1 serving the UE 110, sends a request 91 to the CU 202 for a CFRAR for early timing advance acquisition by the UE with respect to the target DU 204_2 (tDU).

The CU 202 is configured to select the CFRAR, for early timing advance acquisition by the UE, from a set of contention-free-random-access (CFRA) resources for the target DU 204_2 (tDU). The CU 202 provides the selected CFRAR 602 to the sDU1 204_1 serving the UE 110.

The CU 202 is configured to record 94 the CFRAR as not available to other UEs after selecting the CFRAR.

The CU 202 is configured to record 86 the CFRAR as available to other UEs after receiving the early acquired timing advance 42 associated with the CFRAR. This confirms random access completion to the target DU by the UE, and enables release of the CFRAR for use by other UEs served by the different DUs.

FIG. 8 illustrates an example of CFRAR reservation management by the CU 202 when the CU 202 is managing reservation of the CFRARs selected by DUs (FIG. 6).

The CU 202 has recorded 94 the CFRAR as not available to other UEs after selecting the CFRAR.

In this example, a DU, sDU2 204_3, selects a CFRAR, for early timing advance acquisition by a UE, from the set of contention-free-random-access (CFRA) resources, for the target DU 204_2 (tDU). The DU 204_3 (sDU2) provides 95 the selected CFRAR to the central unit 202. The CU 202 determines that received CFRAR is reserved because it is recorded 94 as unavailable. The CU 202 rejects 97 the CFRAR provided by the DU 204_3(sDU2). The CU 202 can, for example, inform the DU 204_3 (sDU2) that a provided CFRAR, which is recorded 94 as not available at the CU 202, is not available.

In these examples, the rejection 97 by the CU 202 can cause the DU 204_3(sDU2) to record 20 the CFRAR as unavailable, and cause the DU 204_3(sDU2) to re-select 10 a CFRAR. The sDU2 204_3, re-selects a new CFRAR, for early timing advance acquisition by a UE, from the set of contention-free-random-access (CFRA) resources, for the target DU 204_2 (tDU) adapted to remove the rejected CFRAR. The DU 204_3 (sDU2) provides the new selected CFRAR to the central unit 202.

The CU 202 is therefore able to determine that more than one DU has selected the same CFRA resource and as a consequence trigger re-selection of a CFRA resource.

In this example, the DU 204_3 (sDU2) reserves the rejected CFRAR for a maximum time period determined by an availability timer 98. The availability timer 98 starts when the rejected CFRAR is recorded 20 as unavailable. When the availability timer expires the rejected CFRAR is recorded 22 as available. The availability timer may be configured by the CU 202.

The duration of this availability timer, may be the same or similar to the duration of the switch timer described with reference to FIG. 4.

It will be appreciated from the foregoing that in at least some examples a DU 204_3 (sDU2) is configured to record a CFRAR, for early timing advance acquisition by the UE with respect to a target DU, as NOT available to any UEs in any cells in response to a signal from a central unit 202 (CU). The DU 204_3 (sDU2) is a non-serving DU and is not serving the subject UE. In the example of FIG. 5, the signal provides 82 the selected CFRAR to the DU 204_3 (sDU2) from the CU 202. In the example of FIG. 8, the signal provides the rejection 97 by the CU 202.

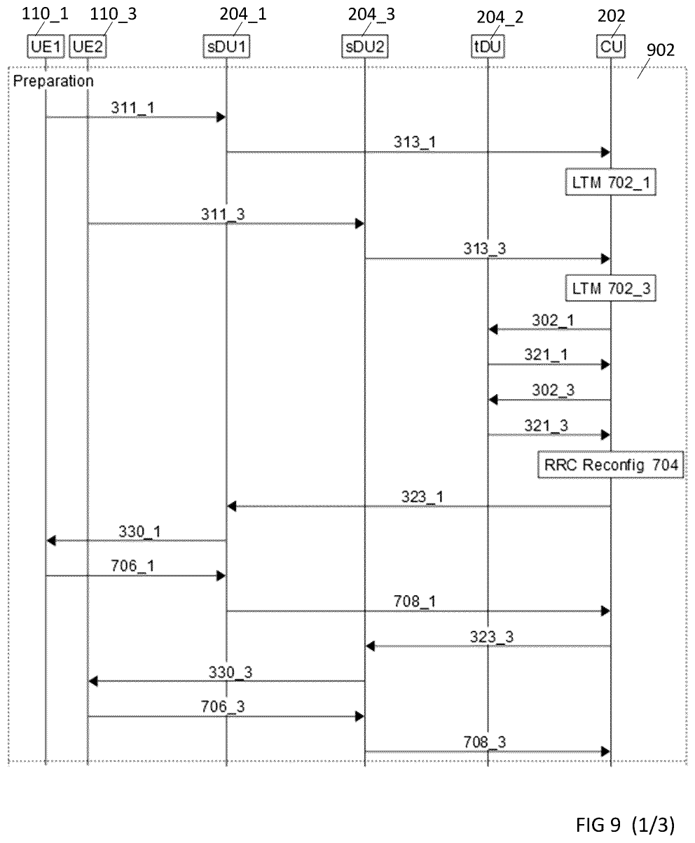

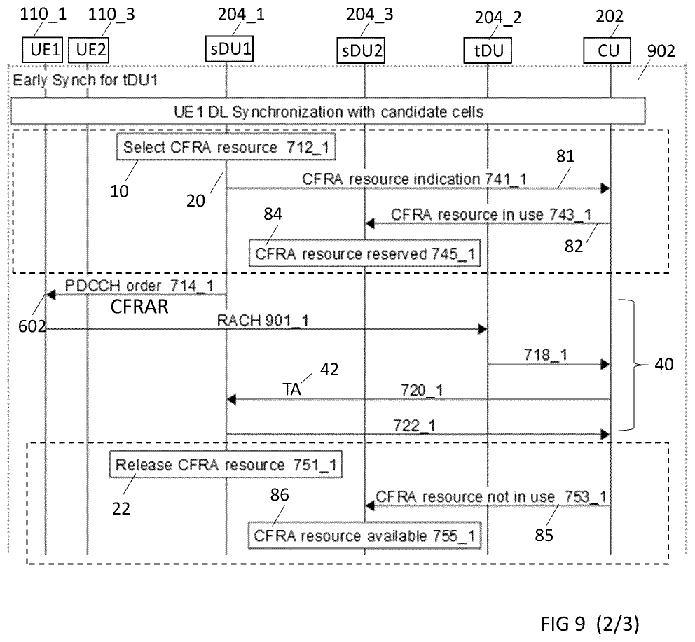

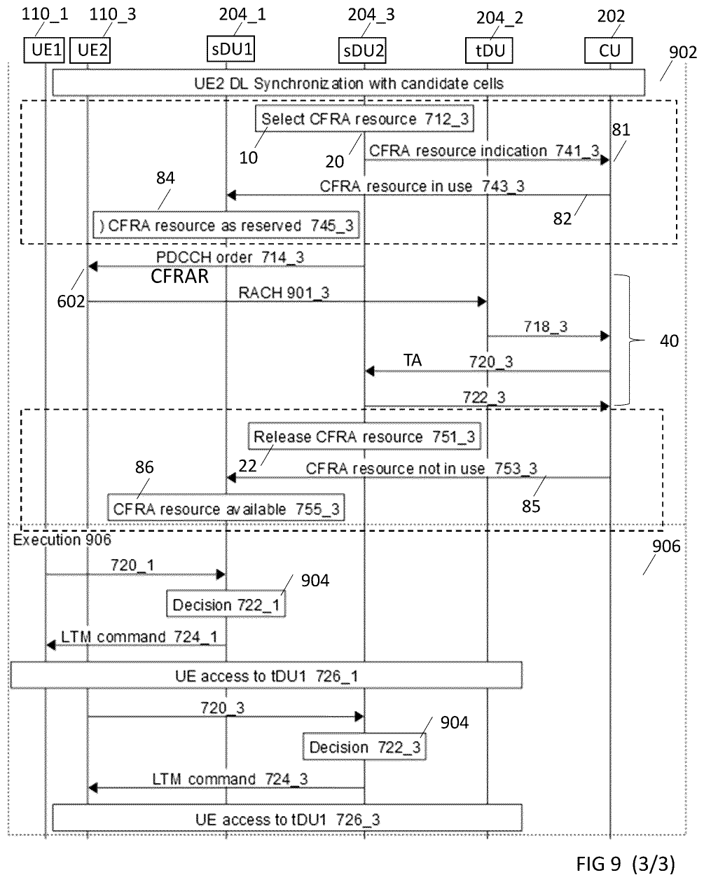

FIG. 9 (divided into three parts) is an example using early synchronization and similar references are used for similar features in previous FIGS. The CFRA is selected at the DU 240 and management of CFRAR contention is at the DUs 240. FIG. 9 is therefore based on FIG. 3A and FIG. 5.

The UE1 110_1 is served by a cell under the source DU1 204_1 (sDU1). The UE2 110_3 is served by a cell under the source DU2 204_3 (sDU2). The target cell is under the target DU 204_2 (tDU).

A target DU and a source DU can be the same entity (i.e., both serving and target cell can be under the same DU). The target DU and a source DU can be different entities (i.e., serving and target cell can be under the different DU). In the latter inter-DU scenario, the target DU and a source DU can be under control of the same CU or the target DU and a source DU can be under control of different CUs.

The LTM process 900 illustrated has a preparation phase 902 and an execution phase 906. The execution phase is caused by trigger 904.

Random access 910 using the a CFRA resource 602 selected from a set of CFRA resources occurs before the cell-switch command 50 is sent, in this example, during the preparation phase 902 of the LTM 900 that precedes the execution phase 904. It occurs before the cell-switch command This is early synchronization for early timing advance acquisition.

The UE1 110_1 sends a L3 Measurement Report message 311_1, 313_1 to the CU 202 via the Source DU 204_1 (sDU1) (The sDU1 204_1 sends UL RRC MESSAGE TRANSFER Message 3131 comprising the L3 Measurement Report to CU 202). The CU 202 decides to use LTM and initiates LTM candidate cells preparation 702_1.

The CU 202 sends a UE context setup request 302_1 to the target DU 204_2 (tDU) for the preparation of the target cells. The target DU 204_2 (tDU) then sends a UE CONTEXT SETUP RESPONSE Message 321_1. This includes the set of CFRA resources for the target DU 204_2 (tDU) to be shared amongst the UEs 110 of the different serving DUs (sDU). The CU 202 receives the message 3211.

The CU 202 prepares 704 the RRC Configuration and provides it 323_1, 330_1 to the UE 110_1 (UE1) via the source DU 204_1 (sDU1). In this example, the message 323_1 from CU 202 to sDU1 204_1 is a DL RRC MESSAGE TRANSFER Message 323_1. The message 330_1 from the sDU1 204_1 to the UE1 110_1 is a RRC Reconfiguration message 330_1.

The UE 110_1 (UE1) stores the configuration of LTM candidate target cell(s) and transmits a RRC Reconfiguration Complete message 706_1, 708_1 to the CU 202 via the source DU 204_1 (sDU1). The message 706_1 from UE1 110_1 to sDU1 204_1 is a RRC Reconfiguration Complete message. The message 70861 from sDU1 204_1 to CU 202 is a UL RRC MESSAGE TRANSFER message 708_1.

The UE 110_1 (UE1) may perform DL early synchronization and early TA acquisition with candidate target cell(s) before receiving the LTM cell switch command 724_1.

The early timing advance (TA) acquisition steps are:

Once Source DU 204_1 (sDU1) decides to trigger PRACH signal transmission from UE1 110_1 towards Target DU 204_2 (tDU), it selects 712_1 a CFRA resource 602 from the set of CFRA resources 602.

Source DU 204_1 (sDU1) sends a CFRA resource indication 741_1 to the CU 202. This indicates the selected CFRA resource (CFRAR).

The CU 202 sends to the source DU 204_3 (sDU2) an indication 743_1 that a CFRA resource is in use. This indicates the selected CFRA resource.

The source DU 204_3 (sDU2) reserves 745_1 the selected CFRA resource. Reservation of a CFRA resource by a DU 204 prevents that CFRA resource being selected by that DU, sDU2.

The process illustrated with respect to sDU2 can occur at other DUs.

Thus when a source DU decides to trigger PRACH signal transmission from a UE towards a target DU 204_2 (tDU), it selects 712 a CFRA resource 602 from the set of CFRA resources 602 for that tDU excluding CFRA resources that have been reserved by that source DU.

The DU 204_1 (sDU1) then sends PDCCH order 714_1 to the UE1 110_1. The PDCCH order 714_1 contains the relevant configuration information (e.g., preamble id, SS/PBCH index, RACH occasion etc.) which includes the selected UE-specific CFRA resource 602.

The source DU 204_1 (sDU1) marks the UE-specific CFRA resource 602 as ‘reserved’ until the UE 110_1 (UE1) completes random access using the UE-specific CFRA resource 602 or there is a release of the UE-specific CFRA resource.

Based on the information received, the UE 110_1 (UE1) triggers random access procedure 910_1 towards the target DU 204_2 (tDU), that is, the preamble transmission over PRACH (i.e., physical random access channel) of the target DU 204_2 (tDU).

After acquiring the timing advance (TA) relevant to the UE 110_1 (UE1), the target DU 204_2 (tDU) provides 718_1, 720_1 the TA value for LTM handover for the target cell together with other relevant information (e.g., preamble id, SS/PBCH index, RACH occasion etc.) to the source DU 204_1 (sDU1) via the CU 202. The source DU 204_1 (sDU1) can now associate the received TA value to the particular UE 110_1 (UE1).

In this example, the message 720_1 is a UE CONTEXT MODIFICATION REQUEST 720_1 indicating acquired TA value for target cell). The sDU1 204_1 responds with

UE CONTEXT MODIFICATION RESPONSE 722_1.

The source DU 204_1 (sDU1) releases 751_1 the selected and reserved CFRA resource. Thus when the source DU 204_1 (sDU1) subsequently decides to trigger PRACH signal transmission from a UE towards the target DU 204_2 (tDU), it selects 712 a CFRA resource 602 from the set of CFRA resources 602 including the CFRA resource that had previously been reserved and is now not reserved.

The CU 202, in response to receiving the TA, sends an indication 753_1 to the other

Source DUs e.g. DU 204_3 (sDU2) that the CFRA resource should now be available. The source DU 204_3 (sDU2) records 755_1 the indicated CFRA resource as available.

The execution phase is triggered 904_1 by lower layer measurement report 720_1 sent from the UE1 110_1 to the serving DU 204_1 (sDU1). The UE 110_1 (UE1) performs L1 measurements on the configured LTM candidate target cell(s), and transmits lower-layer measurement reports 904_1 to the source DU 204_1 (sDU1).

The source DU 204_1 (sDU1) decides 722_1 to execute LTM cell switch to a target cell (tDU 204_2), and transmits a LTM Command 724_1 (a MAC CE) to the UE 110_1 (UE1) triggering LTM cell switch at the UE 110_1 (UE1). The LTM Command 724_1 includes the TA value of target cell.

The UE 110_1 (UE1) switches to the configuration of the LTM candidate target cell (tDU 204_2) and accesses 726_1 the target cell. If needed (i.e., if timing advance is not available/valid), it performs Random Access (not illustrated). The UE 110_1 (UE1) can indicate successful completion of the LTM cell switch towards target cell using an RRC Reconfiguration complete.

The UE2 110_3 sends a L3 Measurement Report message 311_3, 313_3 to the CU 202 via the Source DU 204_3 (sDU2) (The sDU2 204_3 sends UL RRC MESSAGE TRANSFER Message 313_3 comprising the L3 Measurement Report to CU 202). The CU 202 decides to use LTM and initiates LTM candidate cells preparation 702_3.

The CU 202 sends a UE context setup request 302_3 to the target DU 204_2 (tDU) for the preparation of the target cells.

The target DU 204_2 (tDU) then sends a UE CONTEXT SETUP RESPONSE Message 321_3. This includes the set of CFRA resources for the target DU 204_2 (tDU) to be shared amongst the UEs 110 of the different serving DUs (sDU)

The CU 202 receives the message 321_3

The CU 202 prepares 704 the RRC Configuration and provides it 323_3, 330_3 to the UE 110_3 (UE2) via the source DU 204_3 (sDU2). In this example, the message 323_3 from CU 202 to sDU2 204_3 is a DL RRC MESSAGE TRANSFER Message 323_3. The message 3303 from the sDU2 204_3 to the UE2 110_3 is a RRC Reconfiguration message 330_3.

The UE 110_3 (UE2) stores the configuration of LTM candidate target cell(s) and transmits a RRC Reconfiguration Complete message 706_3, 708_3 to the CU 202 via the source DU 204_3 (sDU2). The message 706_3 from UE2 110_3 to sDU2 204_3 is a RRC Reconfiguration Complete message. The message 708_3 from sDU2 204_3 to CU 202 is a UL RRC MESSAGE TRANSFER message 708_3.

The UE 110_3 (UE2) may perform DL early synchronization and early TA acquisition with candidate target cell(s) before receiving the LTM cell switch command 724_3.

The early timing advance (TA) acquisition steps are:

Once Source DU 204_3 (sDU2) decides to trigger PRACH signal transmission from UE1 110_3 towards Target DU 204_2 (tDU), it selects 712_3 a CFRA resource 602 from the set of available CFRA resources 602.
Source DU 204_3 (sDU2) sends a CFRA resource indication 741_3 to the CU 202. This indicates the selected CFRA resource.
The CU 202 sends to the source DU 204_1 (sDU1) an indication 743_3 that a CFRA resource is in use. This indicates the selected CFRA resource.
The source DU 204_1 (sDU1) reserves 745_3 the selected CFRA resource.
Reservation of a CFRA resource by a DU 204 prevents that CFRA resource being selected by that DU.

Thus when a source DU decides to trigger PRACH signal transmission from a UE towards the target DU 204_2 (tDU), it selects 712 a CFRA resource 602 from the set of CFRA resources 602 for the tDU excluding CFRA resources that have been reserved by that source DU.

The source DU 204_3 (sDU2) then sends PDCCH order 714_3 to the UE2 110_3. The PDCCH order 714_3 contains the relevant configuration information (e.g., preamble id, SS/PBCH index, RACH occasion etc.) which includes the selected UE-specific CFRA resource 602.

The source DU 204_3 (sDU2) marks the UE-specific CFRA resource as ‘reserved’ until the UE 110_3 (UE2) completes random access using the UE-specific CFRA resource 602 or there is a release of the UE-specific CFRA resource 602.

Based on the information received, the UE 110_3 (UE2) triggers random access procedure 910_3 towards the target DU 204_2 (tDU), that is, the preamble transmission over PRACH (i.e., physical random access channel) of the target DU 204_2 (tDU).

After acquiring the timing advance (TA) relevant to the UE 110_3 (UE2), the target DU 204_2 (tDU) provides 718_3, 720_3 the TA value for LTM handover for the target cell together with other relevant information (e.g., preamble id, SS/PBCH index, RACH occasion etc.) to the source DU 204_3 (sDU2) via the CU 202. The source DU 204_3 (sDU2) can now associate the received TA value to the particular UE 110_3 (UE2). In this example, the message 720_3 is a UE CONTEXT MODIFICATION REQUEST 720_3 indicating acquired TA value for target cell). The sDU2 204_3 responds with

### UE CONTEXT MODIFICATION RESPONSE 722_3.

The source DU 204_3 (sDU2) releases 751_3 the selected and reserved CFRA resource. Thus when the source DU 204_3 (sDU2) subsequently decides to trigger PRACH signal transmission from a UE towards the target DU 204_2 (tDU), it selects 712_3 a CFRA resource 602 from the set of CFRA resources 602 including the CFRA resource that had previously been reserved and is now not reserved.

The CU 202, in response to receiving the TA, sends an indication 753_3 to the other Source DUs e.g. DU 204_1 (sDU1) that the CFRA resource should now be available. The source DU 204_1 (sDU1) records 755_3 the indicated CFRA resource as available.

The execution phase is triggered 9043 by lower layer measurement report 720_3 sent from the UE2 110_3 to the serving DU 204_3 (sDU2). The UE 110_3 (UE2) performs L1 measurements on the configured LTM candidate target cell(s), and transmits lower-layer measurement reports 904_3 to the source DU 204_3 (sDU2).

The source DU 204_3 (sDU2) decides 722_3 to execute LTM cell switch to a target cell (tDU 204_2), and transmits a LTM Command 724_3 (a MAC CE) to the UE 110_3 (UE2) triggering LTM cell switch at the UE 110_3 (UE2).

The UE 110_3 (UE2) switches to the configuration of the LTM candidate target cell (tDU 204_2) and accesses 726_3 the target cell. If needed (i.e., if timing advance is not available/valid), it performs Random Access (not illustrated).

The UE 110_3 (UE2) can indicate successful completion of the LTM cell switch towards target cell using an RRC Reconfiguration complete.

The above processes avoids PRACH collision in case CFRA resources are shared among UEs connected to different DUs. It prevents source DUs using the same CFRA resource for different UEs which may result in PRACH collision.

A CFRA resource is configured per DU per UE. This prevents a CFRA resource being shared by UEs belonging to different source DUs.

The process avoids CFRA resource starvation problem in dense environment, enables low latency handover by avoiding RACH collisions (HO failures) and enables shared CFRA resource for early TA acquisition.

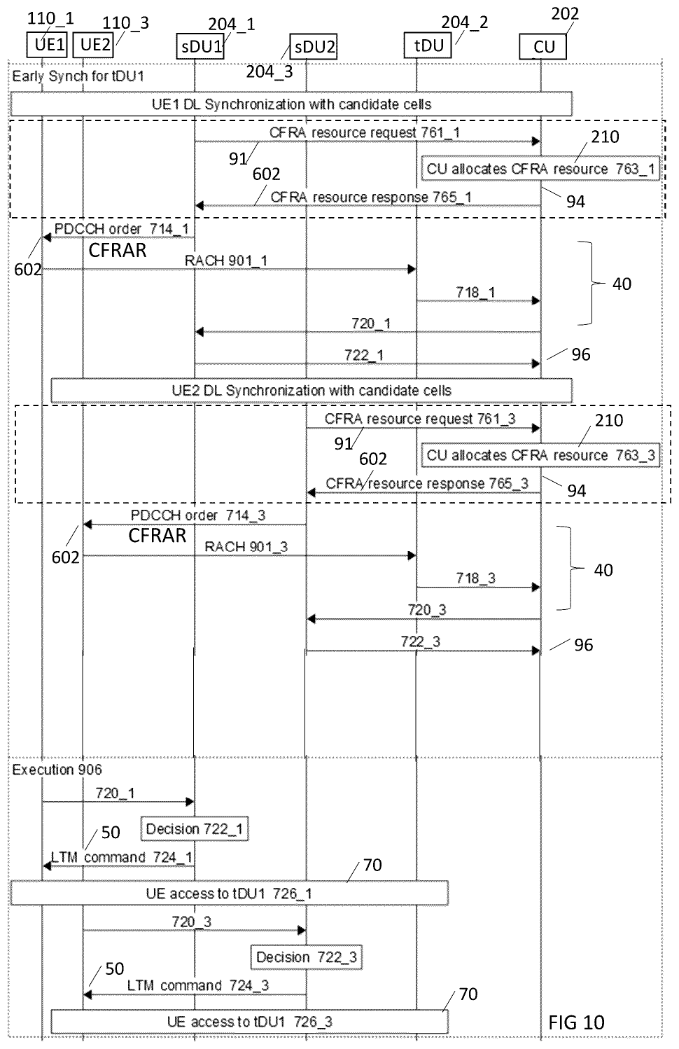

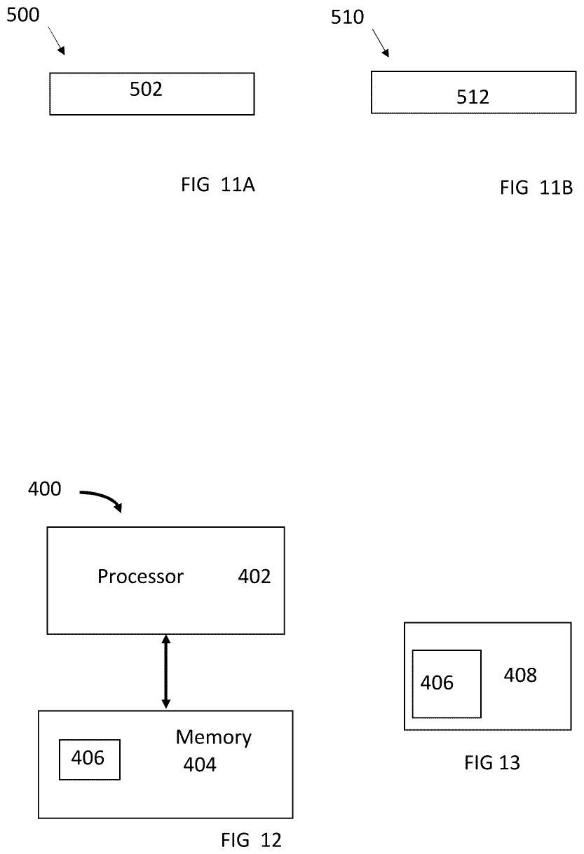

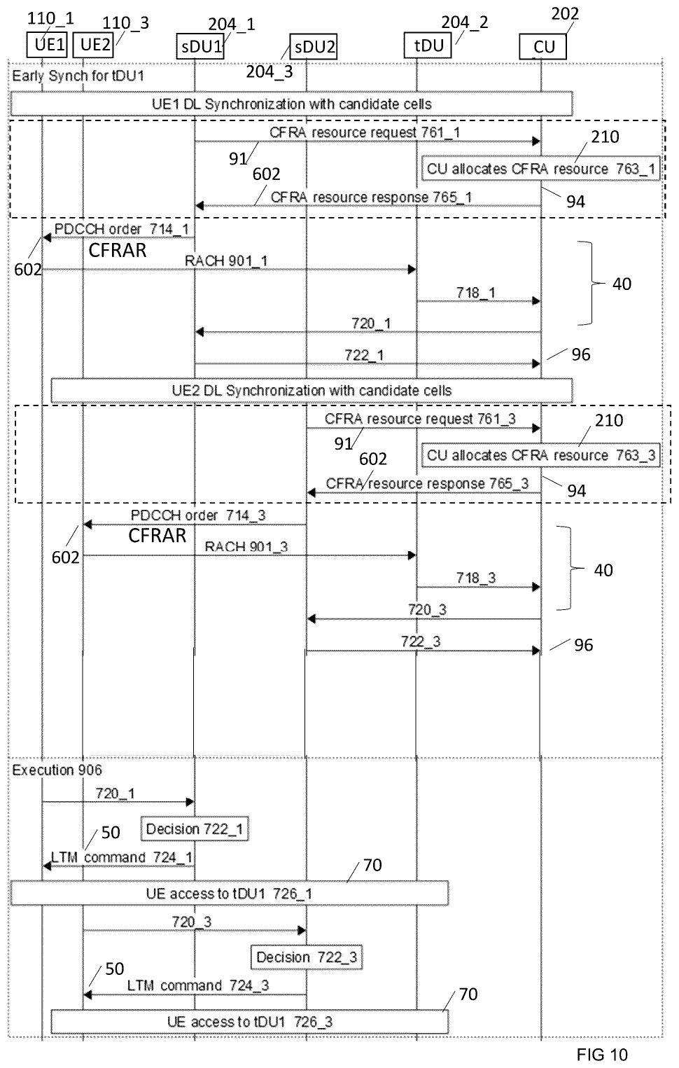

FIG. 10 is an example using early synchronization and similar references are used for similar features in previous FIGS. The CFRAR is selected at the CU 202 and management of CFRAR contention is at the CU 202. FIG. 10 is therefore based on FIG. 3A and FIG. 7.

The preparation phase, previously illustrated in FIG. 9(1/3) is the same and is not reproduced. The execution phase illustrated in FIG. 9(1/3) and described, is the same.

The synchronization phase is different as indicated by dashed boxes.

The early timing advance (TA) acquisition steps are:

Once source DU 204_1 (sDU1) decides to trigger PRACH signal transmission from UE1 110_1 towards Target DU 204_2 (tDU), it sends a CFRA resource request 761_1 to the CU 202.
The CU allocates 763_1 a CFRA resource 602 from the set of available CFRA resources 602 for tDU.
The CU sends a CFRA resource response 765_1 to the Source DU 204_1 (sDU1) indicating the CFRA resource 602 allocated to the UE from the set of CFRA resources 602 for tDU.
The Source DU 204_1 (sDU1) then sends PDCCH order 714_1 to the UE1 110_1. The PDCCH order 714_1 contains the relevant configuration information (e.g., preamble id, SS/PBCH index, RACH occasion etc.) which includes the selected UE-specific CFRA resource 602.

Optionally, the source DU 204_1 (sDU1) marks the UE-specific CFRA resource 602 as ‘reserved’ until the UE 110_1 (UE1) completes random access using the UE-specific CFRA resource 602 or there is a release of the UE-specific CFRA resource.

Based on the information received, the UE 110_1 (UE1) triggers random access procedure 910_1 towards the target DU 204_2 (tDU), that is, the preamble transmission over PRACH (i.e., physical random access channel) of the target DU 204_2 (tDU).

After acquiring the timing advance (TA) relevant to the UE 110_1 (UE1), the target DU 204_2 (tDU) provides 718_1, 720_1 the TA value for LTM handover for the target cell together with other relevant information (e.g., preamble id, SS/PBCH index, RACH occasion etc.) to the source DU 204_1 (sDU1) via the CU 202. The source DU 204_1 (sDU1) can now associate the received TA value to the particular UE 110_1 (UE1).

In this example, the message 720_1 is a UE CONTEXT MODIFICATION REQUEST 720_1 indicating acquired TA value for target cell). The sDU1 204_1 responds with

### UE CONTEXT MODIFICATION RESPONSE 722_1.

The early timing advance (TA) acquisition steps are:

Once source DU 204_3 (sDU2) decides to trigger PRACH signal transmission from UE1 110_3 towards Target DU 204_2 (tDU), it sends a CFRA resource request 761_3 to the CU 202.
The CU 202 allocates 763_3 a CFRA resource 602 from the set of available CFRA resources 602 for tDU.
The CU 202 sends a CFRA resource response 765_3 to the Source DU 204_3 (sDU2) indicating the CFRA resource 602 allocated to the UE 110_3 from the set of CFRA resources 602 for tDU.
The Source DU 204_3 (sDU2) then sends PDCCH order 714_3 to the UE1 110_3. The PDCCH order 714_3 contains the relevant configuration information (e.g., preamble id, SS/PBCH index, RACH occasion etc.) which includes the selected UE-specific CFRA resource 602.

Optionally, the source DU 204_3 (sDU2) marks the UE-specific CFRA resource 602 as ‘reserved’ until the UE 110_3 (UE2) completes random access using the UE-specific CFRA resource 602 or there is a release of the UE-specific CFRA resource.

Based on the information received, the UE 110_3 (UE2) triggers random access procedure 910_3 towards the target DU 204_2 (tDU), that is, the preamble transmission over PRACH (i.e., physical random access channel) of the target DU 204_2 (tDU).

After acquiring the timing advance (TA) relevant to the UE 110_3 (UE2), the target DU 204_2 (tDU) provides 718_3, 720_3 the TA value for LTM handover for the target cell together with other relevant information (e.g., preamble id, SS/PBCH index, RACH occasion etc.) to the source DU 204_3 (sDU2) via the CU 202. The source DU 204_3 (sDU2) can now associate the received TA value to the particular UE 110_3 (UE2).

In this example, the message 720_3 is a UE CONTEXT MODIFICATION REQUEST 720_3 indicating acquired TA value for target cell). The sDU1 204_3 responds with

### UE CONTEXT MODIFICATION RESPONSE 722_3.

FIG. 11A illustrates an example of a method 500. The method 500 can, for example, be performed by a distributed unit 204 (DU) operating as a target distributed unit (tDU). The method 500 at block 502 comprises: enabling lower-layer triggered mobility (LTM) random access by a user equipment (UE) to a target distributed unit (DU), for early timing advance acquisition, using a contention-free-random-access (CFRA) resource, for early timing advance acquisition, reserved for the UE against use by UEs served by different DUs.

FIG. 11B illustrates an example of a method 510. The method 510 can, for example, be performed by a central unit 202 (CU) communicating with a target distributed unit (tDU). The method 510 at block 512 comprises: enabling lower-layer triggered mobility (LTM) random access by a user equipment (UE) to a target distributed unit (DU), for early timing advance acquisition, using a contention-free-random-access (CFRA) resource, for early timing advance acquisition by the UE, reserved for the UE against use by UEs served by different DUs.

FIG. 12 illustrates an example of a controller 400 suitable for use in an apparatus such as a network apparatus 202, 204. Implementation of a controller 400 may be as controller circuitry. The controller 400 may be implemented in hardware alone, have certain aspects in software including firmware alone or can be a combination of hardware and software (including firmware).

As illustrated in FIG. 12 the controller 400 may be implemented using instructions that enable hardware functionality, for example, by using executable instructions of a computer program 406 in a general-purpose or special-purpose processor 402 that may be stored on a computer readable storage medium (disk, memory etc) to be executed by such a processor 402.

The processor 402 is configured to read from and write to the memory 404. The processor 402 may also comprise an output interface via which data and/or commands are output by the processor 402 and an input interface via which data and/or commands are input to the processor 402.

The memory 404 stores a computer program 406 comprising computer program instructions (computer program code) that controls the operation of the apparatus 202, 204 when loaded into the processor 402. The computer program instructions, of the computer program 406, provide the logic and routines that enables the apparatus to perform the methods illustrated in the accompanying FIGS. The processor 402 by reading the memory 404 is able to load and execute the computer program 406.

The apparatus 202 (central unit) comprises:
at least one processor 402; and
at least one memory 404 including computer program code,
the at least one memory storing instructions that, when executed by the at least one processor 402, cause the apparatus 202 at least to:
enabling lower-layer triggered mobility (LTM) random access by a user equipment (UE) to a target distributed unit (DU), for early timing advance acquisition, using a contention-free-random-access (CFRA) resource, for early timing advance acquisition, reserved for the UE against use by UEs served by different DUs.

The apparatus 204 (distributed unit) comprises:
at least one processor 402; and
at least one memory 404 including computer program code,
the at least one memory storing instructions that, when executed by the at least one processor 402, cause the apparatus 204 at least to:
enabling lower-layer triggered mobility (LTM) random access by a user equipment (UE) to a target distributed unit (DU), for early timing advance acquisition, using a contention-free-random-access (CFRA) resource, for early timing advance acquisition by the UE, reserved for the UE against use by UEs served by different DUs.

As illustrated in FIG. 13, the computer program 406 may arrive at the apparatus 202, 204 via any suitable delivery mechanism 408. The delivery mechanism 408 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 406. The delivery mechanism may be a signal configured to reliably transfer the computer program 406. The apparatus 202, 204 may propagate or transmit the computer program 406 as a computer data signal.

Computer program instructions for causing an apparatus 202, as a central unit, to perform at least the following or for performing at least the following:
enabling lower-layer triggered mobility (LTM) random access by a user equipment (UE) to a target distributed unit (DU), for early timing advance acquisition, using a contention-free-random-access (CFRA) resource, for early timing advance acquisition, reserved for the UE against use by UEs served by different DUs.

Computer program instructions for causing an apparatus 204 to perform, as a distributed unit, at least the following or for performing at least the following:
enabling lower-layer triggered mobility (LTM) random access by a user equipment (UE) to a target distributed unit (DU), for early timing advance acquisition, using a contention-free-random-access (CFRA) resource, for early timing advance acquisition by the UE, reserved for the UE against use by UEs served by different DUs.

The computer program instructions may be comprised in a computer program, a non-transitory computer readable medium, a computer program product, a machine readable medium. In some but not necessarily all examples, the computer program instructions may be distributed over more than one computer program.

Although the memory 404 is illustrated as a single component/circuitry it may be implemented as one or more separate components/circuitry some or all of which may be integrated/removable and/or may provide permanent/semi-permanent/dynamic/cached storage.

Although the processor 402 is illustrated as a single component/circuitry it may be implemented as one or more separate components/circuitry some or all of which may be integrated/removable. The processor 402 may be a single core or multi-core processor.

According to some examples, a set of CFRA resources of a target cell belonging to a target DU is shared by UEs in different source cells belonging to first source DU and a second source DU, however, one CFRA resource from the set of CFRA resources is used by a UE in a cell belonging to either first source DU or a second source DU at a given point in time.

The above solution can be realized by following two alternatives.

Alternative 1:

According to some examples, first source DU selects a CFRA resource from the set of CFRA resources to be used by a UE in a cell belonging to first source DU and first source DU provides the selected CFRA resource from the set of CFRA resources to the second source DU via CU. On receiving the selected CFRA resource from the set of CFRA resources, the second source DU determines that the CFRA resource from the set of CFRA resources is not available to be used by UEs in cells belonging to second source DU.

According to some examples, the selected CFRA resource from the set of CFRA resources is signaled by the first source DU to CU and/or by CU to the second source DU reusing UE Context Modification procedure.

According to some examples, the selected CFRA resource from the set of CFRA resources is signaled by the first source DU to CU and/or by CU to the second source DU using a new one-way signaling procedure.

According to some examples, a timer ‘T’ is defined for first source DU on per UE basis and the PDCCH order for a UE for TA acquisition is triggered at the expiry of the timer ‘T’ whereas, the timer ‘T’ is triggered on the selection of CFRA resource from the set of CFRA resources for the UE.

According to some examples, CU indicates to the second source DU the CFRA resource from the set of CFRA resources on determining that the TA value for a UE based on the CFRA resource from the set of CFRA resource has been acquired by the target DU and is provided to the first set of source DU.

According to some examples, second source DU determines that a CFRA resource from the set of CFRA resources is available to be used by UEs in cells belonging to the second source DU after receiving the indication from the CU.

According to some examples, first source DU determines that a CFRA resource from the set of CFRA resources is available to be used by other UEs in cells belonging to the first source DU after receiving the TA value for the UE for which the CFRA resource was selected.

According to some examples, a timer ‘T’ is defined for the second source DU on per CFRA resource from the set of CFRA resources. The timer ‘T’ of first CFRA resource from the set of CFRA resources is triggered on receiving the indication from the first source DU that the first CFRA resource is already selected and on expiry of the timer ‘T’, the second source DU determines that the first CFRA resource is available.

According to some examples, a timer ‘T’ is defined for a UE and the timer ‘T’ is triggered on the reception of PDCCH order and the UE performs random access by transmitting PRACH only when the timer ‘T’ is expired. The timer ‘T’ can be pre-configured or configured by CU/gNB.

According to some examples, if CU determines that more than one source DU has selected the same CFRA resource, the CU sends the corresponding source DUs an indication to trigger reselection of CFRA resources.

According to some examples, the target DU sends the detected preamble and acquired TA value to CU via one-way signaling procedure. Based on the information available at CU, CU forwards the TA value to the relevant source DU.

In summary:

Step 1: During preparation, target DU decides to configure shared CFRA resource pool among UEs in different source DUs.

Step 2: When source DU1 selects a CFRA resource, it indicates the selected CFRA resource to other DUs via CU. In one case, CU indicates the selected CFRA resource to all the DUs which share the selected CFRA resource. In other case, CU indicates the selected CFRA resource to subset of DUs which share the selected CFRA resource.

Step 3: All the other DUs mark the selected CFRA resource as ‘reserved’.

Step 4: Once TA is acquired and indicated to source DU, CU indicates the selected CFRA resource to other DUs.

Step 5: All the other DUs marks the selected CFRA resource as ‘available’.

Alternative 2:

According to some examples, first source DU sends a request to CU to select and provide a CFRA resource from the set of CFRA resources to be used by a UE in a cell belonging to first source DU and CU sends the response providing the selected CFRA resource from the set of CFRA resources to the first source DU. On selecting the CFRA resource from the set of CFRA resources, the CU determines that the CFRA resource from the set of CFRA resources is not available to be used by UEs in cells belonging to either first or second source DU.

According to some examples, the first source DU sends the request to CU to select and provide CFRA resource from the set of CFRA resources as part of UE Context Modification procedure.

According to some examples, a new request and response procedure is defined in order for the first source DU to send the request to CU to select and provide CFRA resource from the set of CFRA resources and receive the selected CFRA resource from the set of CFRA resources.

According to some examples, a CU rejects the request from the first source DU to select and provide a CFRA resource from the set of CFRA resources to be used by a UE in a cell belonging to first source DU. In some cases, a cause value is also indicated as a part of response message in case of rejection. One possible cause value could be “not available CFRA resource from the set of CFRA resources”.

In summary:

Step 1: During preparation, target DU decides to configure shared CFRA resource pool among UEs in different source DUs.

Step 2: When source DU1 needs to initiate early TA acquisition, it sends a CFRA resource request to CU.

Step 3: CU selects a CFRA resource from the pool of CFRA resources.

Step 4: CU indicates the selected CFRA resource to the source DU1.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory or memories that work together to cause an apparatus, such as a mobile phone or server, to perform various functions and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying FIGS. may represent steps in a method and/or sections of code in the computer program 406. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

As used here ‘module’ refers to a unit or apparatus that excludes certain parts/components that would be added by an end manufacturer or a user. The apparatus 202, 204 can be modules.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

1.-32. (canceled)

33. An apparatus configurable for operation as a central unit (CU), the apparatus comprising:
a processor; and
a memory comprising computer-executable instructions that, when executed by the processor, cause the processor to perform the following operations:
selecting a contention-free-random-access (CFRA) resource, for early timing advance acquisition by a user equipment (UE) from a set of contention-free-random-access (CFRA) resources, for early timing advance acquisition by the UE;
communicating with the UE to enable lower-layer triggered mobility (LTM) random access by the UE to a target distributed unit (DU) for early timing advance acquisition;
providing, to the UE, the selected CFRA resource, for early timing advance acquisition by the UE, reserved for the UE against use by UEs served by different DUs, wherein when the DU triggers a physical random access channel (PRACH) signal transmission from a UE towards the target DU, including the selected CFRA, wherein the selected CFRA is marked as reserved until the UE completes the LTM random access; and
triggering, based on the providing of the selected CFRA resource, a cell switch timer, that, upon expiration, causes a cell switch command to be sent to the UE.

34. The apparatus of claim 33, wherein the computer-executable instructions further cause the processor to perform the following operation: providing an early acquired timing advance for the UE and target DU from the target DU via a control unit.

35. The apparatus of claim 34, wherein the computer-executable instructions further cause the processor to perform the following operation: commanding the UE to connect to the target DU using the received early acquired timing advance.

36. The apparatus of claim 35, wherein a medium access command for commanding the UE to connect to the target DU using the received early acquired timing advance, comprises the received early acquired timing advance.

37. The apparatus of claim 36, wherein the computer-executable instructions further cause the processor to perform the following operations:
obtaining the CFRA resource, for early timing advance acquisition by the UE;
providing the obtained CFRA resource, for early timing advance acquisition by the UE to the UE;
recording a CFRA resource as not available;
receiving an early acquired timing advance;
recording the CFRA resource as available; and
sending the cell switch command to the UE.

38. The apparatus of claim 37, wherein the cell switch timer is configured by the CU.

39. The apparatus of claim 38, wherein the computer-executable instructions further cause the processor to perform the following operations: recording the selected CFRA, for early timing advance acquisition by the UE, as not available to any UEs in any cells in response to a signal from the CU.

40. A system comprising:
an apparatus configurable for operation as a central unit (CU:
a processor; and
a memory comprising computer-executable instructions that, when executed by the processor, cause the processor to perform the following operations:
selecting a contention-free-random-access (CFRA) resource, for early timing advance acquisition by a user equipment (UE) from a set of contention-free-random-access (CFRA) resources, for early timing advance acquisition by the UE;
communicating with the UE to enable lower-layer triggered mobility (LTM) random access by the UE to a target distributed unit (DU) for early timing advance acquisition;
providing, to the UE, the selected CFRA resource, for early timing advance acquisition by the UE, reserved for the UE against use by UEs served by different DUs, wherein when the DU triggers a physical random access channel (PRACH) signal transmission from a UE towards the target DU, including the selected CFRA, wherein the selected CFRA is marked as reserved until the UE completes the LTM random access; and
triggering, based on the providing of the selected CFRA resource, a cell switch timer, that, upon expiration, causes a cell switch command to be sent to the UE.

41. The system of claim 40, wherein the computer-executable instructions further cause the processor to perform the following operation: providing an early acquired timing advance for the UE and target DU from the target DU via a control unit.

42. The system of claim 41, wherein the computer-executable instructions further cause the processor to perform the following operation: commanding the UE to connect to the target DU using the received early acquired timing advance.

43. The system of claim 42, wherein a medium access command for commanding the UE to connect to the target DU using the received early acquired timing advance, comprises the received early acquired timing advance.

44. The system of claim 43, wherein the computer-executable instructions further cause the processor to perform the following operations:
obtaining the CFRA resource, for early timing advance acquisition by the UE;
providing the obtained CFRA resource, for early timing advance acquisition by the UE to the UE;
recording a CFRA resource as not available;
receiving an early acquired timing advance;
recording the CFRA resource as available; and
sending the cell switch command to the UE.

45. The system of claim 44, wherein the cell switch timer is configured by the CU.

46. The system of claim 45, wherein the computer-executable instructions further cause the processor to perform the following operations: recording the selected CFRA, for early timing advance acquisition by the UE, as not available to any UEs in any cells in response to a signal from the CU.

47. A method comprising:
selecting a contention-free-random-access (CFRA) resource, for early timing advance acquisition by a user equipment (UE) from a set of contention-free-random-access (CFRA) resources, for early timing advance acquisition by the UE;
communicating with the UE to enable lower-layer triggered mobility (LTM) random access by the UE to a target distributed unit (DU) for early timing advance acquisition;
providing, to the UE, the selected CFRA resource, for early timing advance acquisition by the UE, reserved for the UE against use by UEs served by different DUs, wherein when the DU triggers a physical random access channel (PRACH) signal transmission from a UE towards the target DU, including the selected CFRA, wherein the selected CFRA is marked as reserved until the UE completes the LTM random access; and
triggering, based on the providing of the selected CFRA resource, a cell switch timer, that, upon expiration, causes a cell switch command to be sent to the UE.

48. The method of claim 47, further comprising providing an early acquired timing advance for the UE and target DU from the target DU via a control unit.

49. The method of claim 48, further comprising commanding the UE to connect to the target DU using the received early acquired timing advance.

50. The method of claim 49, wherein a medium access command for commanding the UE to connect to the target DU using the received early acquired timing advance, comprises the received early acquired timing advance.

51. The method of claim 50, further comprising:
obtaining the CFRA resource, for early timing advance acquisition by the UE;
providing the obtained CFRA resource, for early timing advance acquisition by the UE to the UE;
recording a CFRA resource as not available;
receiving an early acquired timing advance;
recording the CFRA resource as available; and
sending the cell switch command to the UE.

52. The method of claim 51, further comprising:
recording the selected CFRA, for early timing advance acquisition by the UE, as not available to any UEs in any cells in response to a signal from a central unit (CU), wherein the cell switch timer is configured by the CU.
